(19) United States
(12) Patent Application Publication
(10) Pub. No.: US 2013/0276488 A1
(43) Pub. Date: Oct. 24, 2013

(54) MOTOR DRIVEN LOCK FOR TRUCK DOOR

(71) Applicant: Greg Haber, Woodbury, NY (US)

(72) Inventor: Greg Haber, Woodbury, NY (US)

(73) Assignee: BABACO ALARM SYSTEMS, INC., Moonachie, NJ (US)

(21) Appl. No.: 13/549,682

(22) Filed: Jul. 16, 2012

Related U.S. Application Data
(60) Provisional application No. 61/636,852, filed on Apr. 23, 2012.

(51) Int. Cl. E05B 47/00; E05B 65/14

(52) U.S. Cl. 70/57.1; 70/275

(57) ABSTRACT

The lock includes a latch member moveable between a retracted position where the truck door can be moved and an extended position where movement of the door is prevented. The latch member is moved by a reversible motor connected to drive a threaded screw through a set of speed reduction gears. An internally threaded drive nut is moveable along the screw. The drive nut has a radially extending protrusion which engages a slot formed in the latch member. Limit switches are tripped by the latch member at either end of its path of movement. The drive nut is situated between two springs. A control circuit is provided to regulate the energization of the motor and other functions of the lock.

### CROSS-REFERENCE TO RELATED APPLICATIONS

Priority is claimed on provisional patent application Ser. No. 61/636,852, filed Apr. 23, 2012.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to security locks for truck doors, and more particularly, to a motor driven lock for securing a roll-up door of a truck to protect the cargo stored in the truck from theft.

2. Description of Prior Art Including Information Disclosed Under 37 CFR 1.97 and 1.98

Motor driven locks for securing the doors of cargo containing trucks and trailers are known in the art. One such lock is disclosed in U.S. Pat. No. 7,059,159 issued to Lanigan et al. on Jun. 13, 2006. Locks of that type commonly utilize a reversible electric motor to rotate a screw to move a drive nut along the axis of the screw, in a direction depending upon the direction of screw rotation. The drive nut is connected to a latch member which moves linearly with the drive nut to engage and disengage a door jamb, if the door is of the roll-up type, or another door, if the lock is used to secure side-by-side swinging doors.

However, conventional motorized locks suffer from various disadvantages, including being unable to develop sufficient torque to quickly and reliably move the latch member, as well as the inability to prevent vibrations resulting from the normal operation of the truck from causing displacement of the drive nut and hence unwanted movement of the latch member. Further, they lack a mechanism for reliably protecting the motor from burning in the event that the path of movement of the latch member is blocked.

It is, therefore, a prime object of the present invention to provide a motor driven lock for a truck door.

It is another object of the present invention to provide a motor driven lock for a truck door which has the ability to develop sufficient torque to quickly and reliably move the latch member.

It is another object of the present invention to provide a motor driven lock for a truck door in which vibrations resulting from the normal operation of the truck will not result in unwanted movement of the latch member.

It is another object of the present invention to provide a motor driven lock for a truck door in which the motor is protected against damage in the event that movement of the latch is blocked.

It is another object of the present invention to provide a motor driven lock for a truck door which monitors the current drawn by the motor and automatically turns the motor off in the event that the current drawn by the motor exceeds a pre-determined level.

It is another object of the present invention to provide a motor driven lock for a truck door which the spring associated with the latch member is compressed without damaging the lock, if movement of the latch member toward the extended position is blocked.

It is another object of the present invention to provide a motor driven lock for a truck door which can be controlled remotely.

It is another object of the present invention to provide a motor driven lock for a truck door which can be disabled remotely, for a period of time, either with the latch in the retracted position, so that the lock is not used at all, or with the latch in the extended position, wherein the truck door cannot be opened.

It is another object of the present invention to provide a motor driven lock for a truck door which monitors the position of the door such that the motor cannot be energized if the door is not in the correct position.

It is another object of the present invention to provide a motor driven lock for a truck door which provides an audible signal indicating the state of the lock.

It is another object of the present invention to provide a motor driven lock for a truck door which is powered by the electrical system of the truck.

It is another object of the present invention to provide a motor driven lock for a truck door which may be connected to automatically arm the alarm system of the truck.

### BRIEF SUMMARY OF THE INVENTION

The above objects are achieved by the present invention which relates to a lock for the door of a truck. The lock includes a latch member moveable between a retracted position wherein the door can be moved and an extended position wherein the door cannot be moved. Means are provided for moving the latch member between the retracted position and the extended position. The moving means includes a reversible motor having an output shaft. Speed reducing gear means are operably connected to the motor output shaft in order to increase the torque on a threaded drive screw. An internally threaded drive nut is situated on and moveable along the screw, as the screw is rotated. The drive nut has a radially extending protrusion. The latch member is situated proximate at least a portion of the screw and has a slot extending parallel to the screw axis which receives the protrusion. A first spring extends between the drive nut and the latch member. Means are provided for controlling the energization of the motor.

The lock also includes a second spring. The second spring extends between the gear means and the drive nut in a direction opposite that of the first spring. Thus, the drive nut is situated between the first and the second springs.

The first spring is compressed in response to the blockage of the movement of the member towards the extended position. The second spring protects the unit when the member cannot be moved to its retracted position because of interference.

A limit switch is situated proximate the path of movement of the latch member. The controlling means de-energizes the motor when the latch member contacts the limit switch.

Preferably, first and second spaced limit switches are situated proximate the path of movement of the latch member. The controlling means de-energizes the motor when the latch member contacts either limit switch.

The controlling means may include a remote control. The remote control may take the form of an RF module.

The lock also includes means for sensing when the door is closed. Means are provided for connecting the door position sensing means and the motor controlling means.

The controlling means controls the direction of motor energization.

Means are provided for connecting the motor to the ignition circuit of the vehicle.

Means are provided for generating an audible signal. The audible signal generating means may include a speaker and/or a siren powered by the electrical system of the truck in response to a signal from the controlling means.

Means are provided for monitoring the current drawn by the motor. Means are also provided for operatively connecting the current monitoring means and the controlling means. The connecting means includes an operational amplifier.

The controlling means includes means for automatically de-energizing the motor in response to the motor drawing current above a pre-set level.

The truck has an alarm system. The controlling means includes means for generating a signal to the truck alarm system to arm the alarm system and control the alarm system remotely or by RF, Bluetooth or a cellular signal.

### BRIEF DESCRIPTION OF THE SEVERAL VIEWS OF DRAWINGS

To these and to such other objects that may hereinafter appear, the present invention relates to a motor driven lock for a truck door as described in detail in the following specification and recited in the annexed claims, taken together with the accompanying drawings, in which like numerals refer to like parts and in which:

FIG. 1 is a perspective view of the motor, latch member and guides of the lock of the present invention;

FIG. 2 is a perspective view of the motor, gear box, drive screw and nut, and limit switches of the motor;

FIG. 3 is an exploded perspective view of the mechanical components of the lock;

FIG. 4 is a block diagram of the electrical components of the lock; and

FIG. 5 is a circuit diagram of the control circuitry of the lock.

### DETAILED DESCRIPTION OF THE INVENTION

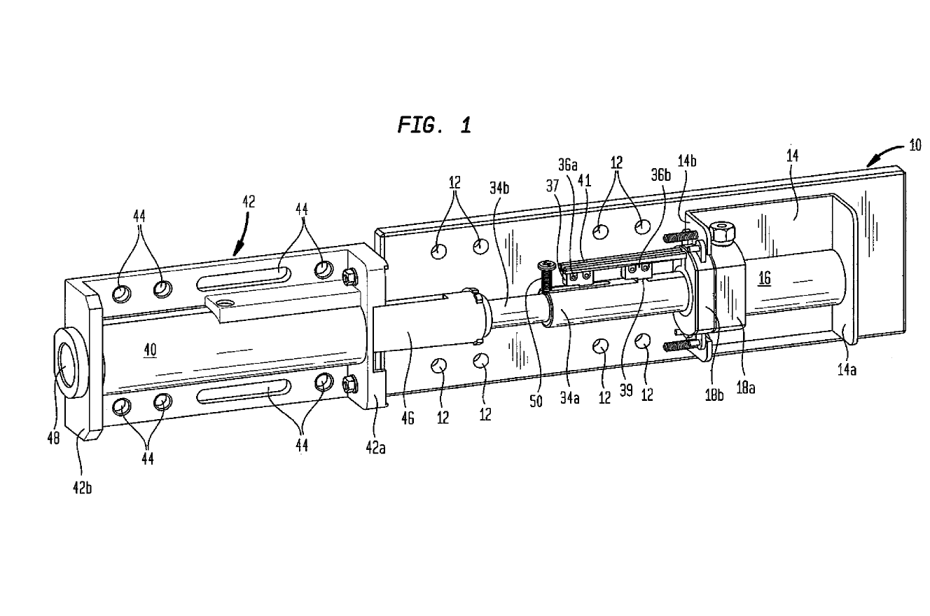

As seen in FIG. 1, the motor driven lock of the present invention includes a base 10 designed to be affixed to the interior surface of a truck door (not shown) by means of screws (not shown). Base 10 has holes 12 for mounting a guide member, as explained below. Permanently fixed to the surface of base 10 is a generally “U” shaped bracket 14, including a rear wall 14a and a front wall 14b, the latter having a central opening.

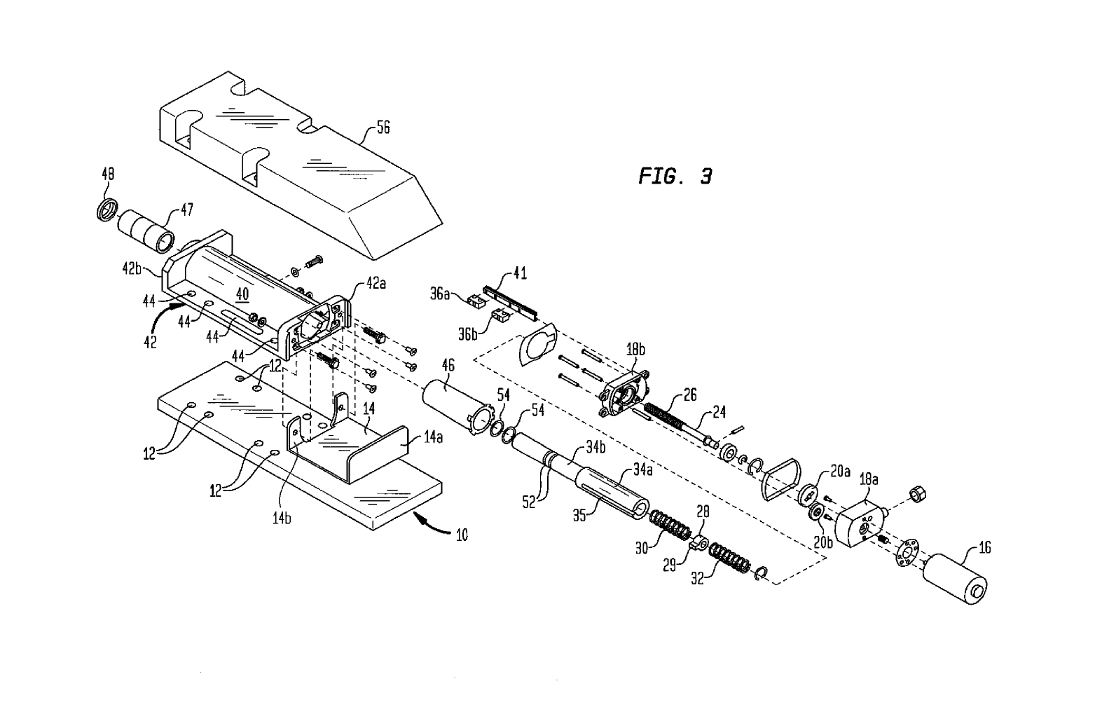

Mounted between walls 14a and 14b of bracket 14 is a reversible electric motor 16. A gear box 18, including a housing formed of parts 18a, 18b which enclose a set of two speed reduction gears 20a, 20b (see FIG. 3). Gear box 18 is mounted on bracket front wall 14b, within the central opening of front wall 18b, and is connected to the bracket front wall by screws.

Gear box 18 is connected between the output shaft of motor 16 and a rotatable drive shaft 24. Gears 20 reduce the speed of the motor output shaft and increase the torque applied to the drive shaft in order to quickly and more reliably move the latch member.

The rotation of drive shaft 24 causes the latch member 34 to move between an extended position in which the latch member engages the door jamb of the truck preventing movement of the door and a retracted position wherein the door jamb is not engaged and the door can be moved to the open position.

A cylindrical guide member 40 is mounted to a bracket 42, between walls 42a and 42b. Bracket 42 is in turn mounted to base 10 by screws (shown on FIG. 3) which extend through holes 44 which align with holes 12 in base 10.

A first hollow guide 46 is situated in the end of guide member 40 facing motor 16. The inside diameter of guide 46 is slightly larger than the outside diameter of the larger portion 34a of match member 34.

A second hollow guide 47 is received in the opposite end of guide member 40 and terminates in end cap 48. End cap 48 has a central opening slightly larger than the diameter to the smaller portion 36b of latch member 34. Guides 46 and 47 serve to guide latch member 34 as the latch member extends through guide member 40 and out through the opening in end cap 48.

Portion 34a of latch member 34 has a first slot 35 which extends from the end facing motor 16 toward but does not reach the other end of member 34, as seen in FIG. 3. Portion 34a also has a second slot 37, as seen in FIG. 1, situated opposite first slot 35, which extends from the end of portion 34a facing away from motor 16 about half way along portion 34a of the latch member.

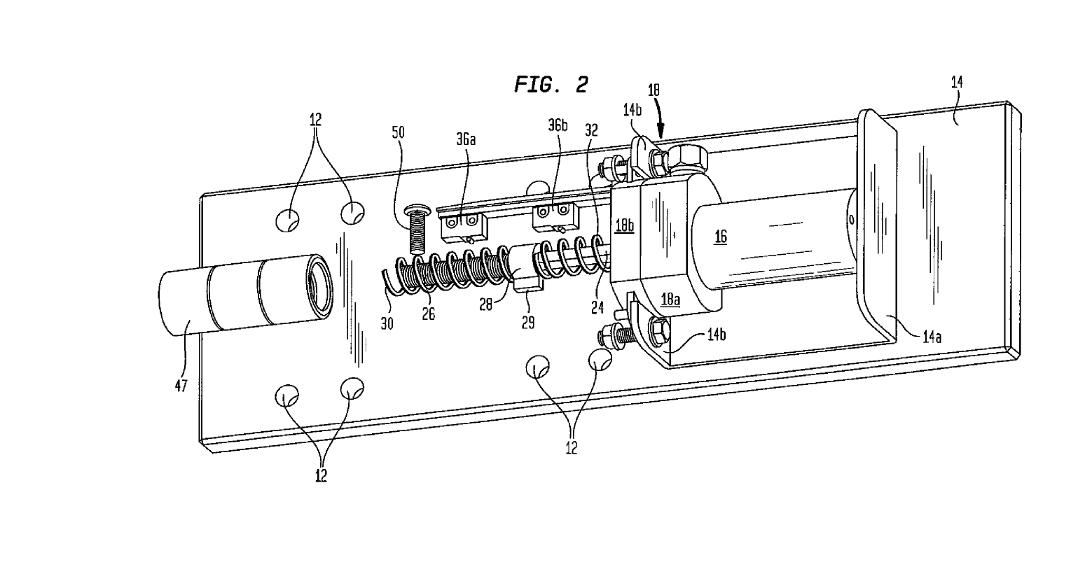

As seen in FIG. 2, drive shaft 24 has an externally threaded portion 26. An internally threaded drive nut 28 is situated on and engages the externally threaded portion 26 of the drive shaft. Drive nut 28 is adapted to move linearly along portion 26 of shaft 24 as the shaft is rotated. The direction of linear movement of the drive nut along the threaded portion of the shaft is determined by the direction in which the motor output shaft is rotated by the reversible motor 16.

Drive nut 28 has a radially extending part 29 which is received within slot 35 in portion 34a of the latch member. As drive shaft 24 is rotated by the motor through gear box 18, part 29 of the drive nut is moved linearly along slot 35 until the latch member reaches its extended position, which will occur before part 29 of the drive nut 28 engages the end of the slot.

The latch member will move forward until a protrusion 39 on the surface of portion 34a contacts the forward limit switch 36a of a pair of spaced limit switches 36a, 36b. That will cause the motor to turn off. The limit switches are mounted adjacent the latch member on a bracket 41 extending from housing portion 18b of the gear box.

If the direction of rotation of the motor output shaft is reversed, the drive nut will move along shaft 24 in the opposite direction, toward the motor. That will cause part 29 of the drive nut, and thus the latch member, to move toward the motor until protrusion 39 on portion 34a of the latch member contacts the rear limit switch 36b. Once limit switch 36b is tripped, the motor is turned off. Thus, limit switches 36a and 36b serve to turn the motor off when the latch member reaches either its extended or its retracted position.

Two springs 30 and 32 surround portions of drive shaft 24. Spring 30 surrounds the threaded portion 26 of the drive shaft and extends between drive nut 28 and the latch member 34. The end of spring 30 is fixed to the latch member. Spring 30 transfers the movement of drive nut 28 to the latch member 34 such that the latch member 34 moves along with the drive nut.

However, spring 30 is longer than the threaded portion 26 of shaft 24 such that a small portion of the spring extends beyond the end of shaft 24. The purpose of that extended portion of the spring is to compress, allowing the motor to continue to run for a period of time, even if the path of travel of the latch member is obstructed. As the motor compresses the spring, the amount of current drawn by the motor will increase beyond a pre-set threshold, which will cause the motor to automatically turn off and protect the motor from burning out.

As noted below, a sensor associated with each of the commutators of motor 16 is provided to monitor the amperage being used by the motor. If the amperage drawn by the motor exceeds a pre-set threshold because the path of movement of the latch member is blocked, the motor will be automatically turned off. Thus, if the maximum current threshold is exceeded, the motor will turn off, even if one of the limit switches is not tripped. Accordingly, there are two level of motor protection provided, one actuated by the latch member reaching a particular position as sensed by the limit switches and a second which is actuated in repose to a current overload on the motor.

Spring 32 surrounds the non-threaded portion of drive shaft 24 and extends between drive nut and the end of the latch member facing the motor. Spring 32 urges the drive nut toward the threaded portion 26 of drive shaft 24. In the event that the drive nut moves off the threaded portion of the drive shaft as it moves toward the motor before limit switch 36b is tripped, when direction of rotation of shaft 24 is reversed, the urging of spring 32 will automatically cause the drive nut to re-engage the threaded of portion 26 of the shaft.

Moreover, springs 30 and 32 bear against opposite sides of drive nut 28 and prevent drive nut 28 from moving along the drive shaft except when the drive shaft is rotated by the motor. Thus, the springs also prevent the normal movements of the truck and associated vibrations to which the lock is subjected during use from causing unwanted movement of the drive along shaft 24, resulting in accidental opening of the lock.

As best seen in FIG. 3, shaft 24 is situated in a stationary tubular member 33 which has a slot 33a extending parallel to the axis of shaft 24. Drive nut 28 has a radially extending protrusion 29 which is situated in slot 33a. The shaft is rotated the protrusion cooperates with the slot to cause the drive nut to move linearly along the threaded portion of the shaft.

Referring again to FIG. 1, a large screw 50 is situated within an internal bore (not shown) in portion 34b of the latch member and extends radially from the match member. Screw 50 is received in slot 37 of latch member portion 34a. Screw 50 acts as a stop, preventing the latch member from extending beyond its extended position.

The latch member includes a large diameter hollow cylindrical member 34a into which the drive shaft, drive nut and springs are received. The other portion 36b of the latch member, which has a smaller diameter, extends from portion 36a and is solid. The surface of portion 36a is provided with two circumferential grooves 52. Grooves 52 are designed to receive rubber O-rings 54. O-rings 54 bear against the interior surface of guide 47 so as to prevent any dirt or debris which may be situated on the latch member from entering the lock as the latch member is retracted. A cover 56 is provided to enclose the entire lock mechanism.

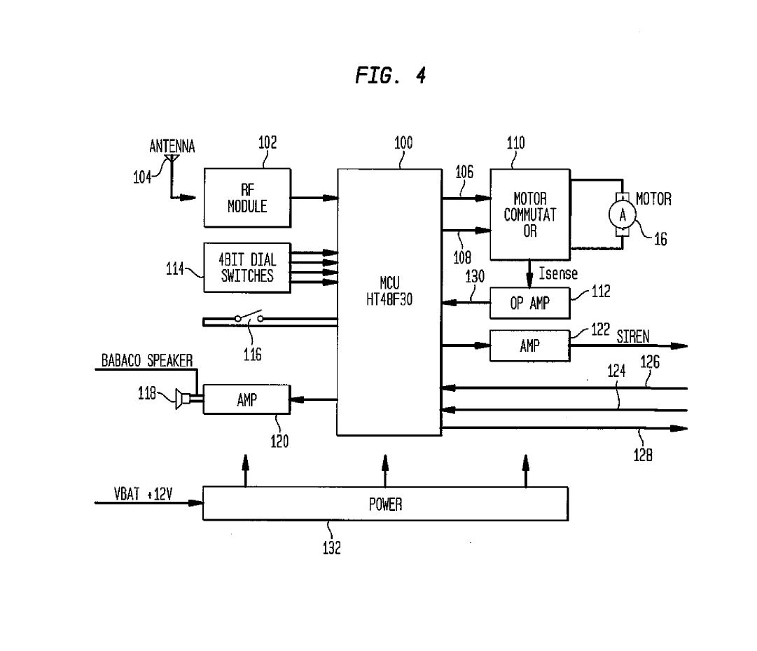

FIG. 4 is a block diagram of the electronic components which control the lock of the present invention. The operation of the lock is controlled by Microcontroller 100 (MCU) which may take the form of an I/O Flash Type MCU with an internal EEPROM, such as item number HT48F30 available from Holtek Semiconductor (USA) Inc. of Fremont, Calif. or a similar microcontroller. MCU 100 receives commands from a remote control transmitter (not shown) through a RF Module 102 connected to an antenna 104.

MCU 100 controls the operation of motor 16 through two outputs 106, 108 connected to the separate commutators 110 of motor 16. A signal applied to one of the two outputs causes motor 16 to rotate drive shaft 24 in one direction. A signal applied to the other of the two outputs causes the motor to rotate drive shaft 24 in the opposite direction.

The operation of the motor, and particularly the amount of current being drawn by the motor is monitored and a signal reflecting the level of current drawn by the motor appears on output 134. An operational amplifier 112 is connected to receive the signal on output 134. It generates a signal to MCU 100 in the event that the current drawn by the motor exceeds a pre-set threshold, indicating that the movement of the latch member 34 is blocked. In response, MCU will automatically turn off the motor so that it does not burn out.

A series of 4 bit dial switches 114 are used to set certain parameters of the lock operation. One of the switches 114 causes MCU 100 to automatically activate the motor to advance the latch member and lock the door a certain time (for example, 15 seconds) after the truck door is closed. Another of the switches 114 causes the motor to be activated upon command to open or close the lock. A third switch 114 allows to the operator to use voice commands to control the lock. Still another switch 114 allows MCU 100 to activate an audible alarm in the form of a speaker or siren in the event that the door is moved from its closed position after the alarm is armed.

A switch 116 is located in the path of the truck door and serves to sense when the door is in the closed position. MCU 100 cannot energize the motor to advance the latch member toward its extended position unless switch 116 senses that the door is in its closed position. Further, the audible alarm circuit cannot be armed unless the latch member is in its extended position.

Two possible audible alarms may be used with the unit. One alarm consists of a speaker 118 which is controlled by one of the MCU outputs and is powered by a 12 volt battery 120, which also powers the MCU and the other electrical components. The other audible alarm is a siren (not shown) powered by the vehicle electrical system and activated by an alarm signal output from the MCU through amplifier 122. Amplifier 122 is also connected to battery 132.

In addition, MCU 100 is connected to receive a signal from the truck ignition circuit at 124. The ignition signal indicates the when the truck ignition is “on” so that the lock motor can be activated. MCU 100 also receives a signal on 126 from an external device, such as a manual switch, causing the MCU activate the motor to move the latch member to lock or unlock the lock.

The MCU also generates a signal at 128 which may be connected to operate an external system, such as the truck alarm system. That signal may arm the truck alarm system a given time after the latch member is extended, for example.

The control unit has an internal alarm feature which provides an audible signal when the control unit receives a signal to activate or deactivate the lock. The audible signal may be different for each function, if desired.

Further, the control unit has an input to power the control unit. The control unit can then direct power to an external battery to charge the battery to provide back-up power when required.

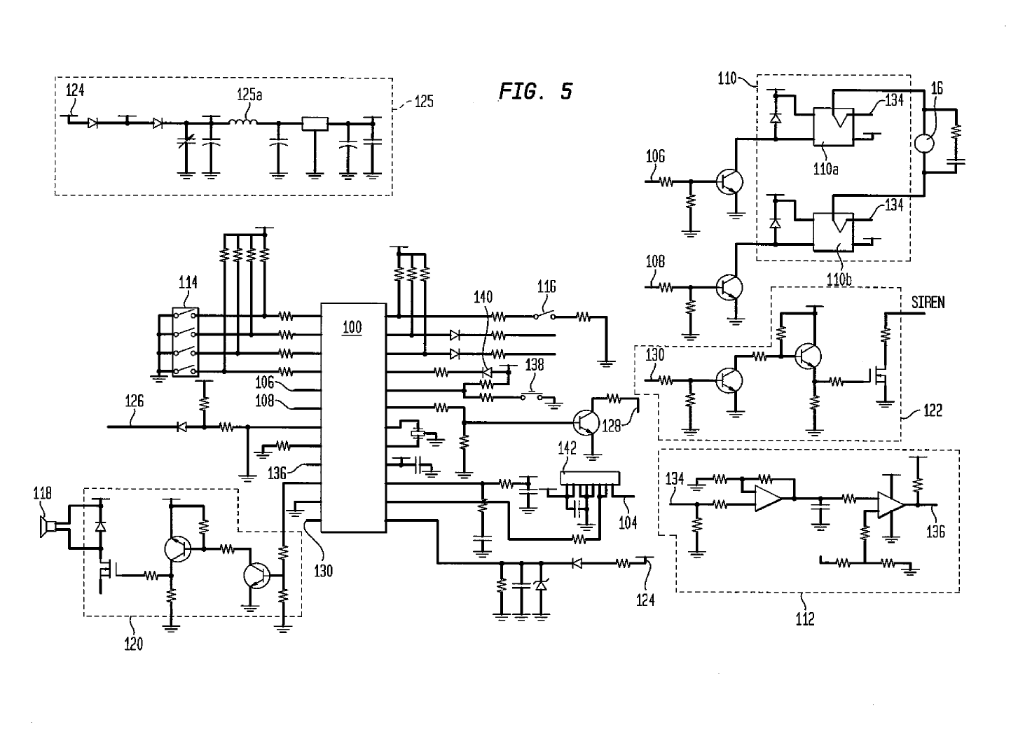

FIG. 5 is a schematic of the circuitry showing the interconnections between the components in greater detail. MCU 100 is connected to commutators 110 of motor 16, through outputs 106 and 108. Generating a signal on one of those outputs energizes the connected commutator to rotate shaft 24 in one direction or the other, to extend or retract the latch member.

Amplifier 122 is connected to drive the siren (not shown) in response to an alarm signal from the MCU on lead 130. MCU generates the alarm signal on lead 130 which actuated the siren which is powered by the electrical system of the truck.

An ignition signal is applied to lead 124 from the ignition circuit 125 of the truck. The circuit includes ignition coil 125a.

Speaker 118 and amplifier 120 are connected to the speaker output of MCU 100. When a signal is generated on the speaker output, the amplifier and speaker are connected to battery 132 to cause the speaker to generate an audible alarm signal.

A GPS signal may be provided to the MCU at lead 126. The GPS signal may cause MCU 100 to automatically actuate the motor to extend the latch member if the truck is moved. The 4 bit dial switches 114 are connected to the MCU to set the parameters of operation of the lock, as explained previously.

The input of operational amplified 112 is connected to both of the commutators 110a and 110b of motor 16 by leads 134. The output of the operational amplifier 112 is connected to an input 136 of MCU 100 which will automatically de-energize the motor in the event of a current overload.

The circuitry also includes a switch 138 and a Red LED 140. Switch 138 is used to cause the MCU to learn the code to communicate with RF Module 102 with code hopping, employing an algorithm to protect against code cloning. The LED 140 is energized while the learning procedure is taking place. A connector 142 is provided for connecting to the RF Module 102 to MCU 100.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A lock for the door of a truck comprising: a member moveable between a retracted position wherein the door can be moved and an extended position wherein the movement of the door is prevented; means for moving said member between said retracted position and said extended position, said moving means comprising a reversible motor having an output shaft; speed reducing gear means operably connected to said motor output shaft; a threaded screw having an axis and being connected to said gear means; an internally threaded drive nut situated on and moveable along said screw, said drive nut having a radially extending protrusion; said member having a slot extending parallel to said screw axis which is adapted to receive said protrusion; a first spring extending between said drive nut and said member in a first direction; and means for controlling the energization of said motor.

2. The lock of claim 1 further comprising a second spring extending between said drive nut and said member in a second direction.

3. The lock of claim 1 wherein said first spring is compressed in response to the blockage of the movement of the member towards the extended position.

4. The lock of claim 1 further comprising a limit switch situated proximate the path of movement of said member.

5. The lock of claim 1 further comprising first and second spaced limit switches situated proximate the path of movement of said member.

6. The lock of claim 1 wherein said motor controlling means comprises a RF remote control.

7. The lock of claim 4 wherein said controlling means de-energizes said motor when said member contacts said limit switch.

8. The lock of claim 5 wherein said controlling means de-energizes said motor when said member contacts either of said first or said second limit switch.

9. The lock of claim 1 further comprising means for sensing when the door is closed and means for connecting said sensing means and said controlling means.

10. The lock of claim 1 wherein said controlling means controls the direction of motor energization.

11. The lock of claim 2 wherein said drive nut is situated between said first spring and said second spring.

12. The lock of claim 1 further comprising means for generating an audible signal.

13. The lock of claim 12 wherein said audible signal generating means comprises a speaker energized by said controlling means.

14. The lock of claim 12 wherein said audible signal generating means comprises a siren powered by the electrical system of the truck in response to a signal from said controlling means.

15. The lock of claim 1 further comprising means for monitoring the current drawn by said motor and means for operatively connecting said current monitoring means and said controlling means.

16. The lock of claim 15 wherein said connecting means comprises an operational amplifier.

17. The lock of claim 15 wherein said controlling means comprises means for de-energizing said motor in response to the motor drawing current above a pre-set level.

18. The lock of claim 1 further comprising means for connecting said controlling means to the ignition system of the truck.

19. The lock of claim 1 wherein said truck has an alarm system and wherein said controlling means causes arming of the truck alarm system.
